(19) United States
(12) Patent Application Publication
(10) Pub. No.: US 2024/0396987 A1
(43) Pub. Date: Nov. 28, 2024

(54) DYNAMIC GENERATION OF A MOBILE CONTACT PRIORITY LIST

(71) Applicant: International Business Machines Corporation, Armonk, NY (US)

(72) Inventors: VISHNU KRISHNAN, Kottayam (IN); Ebey John, Ernakulam (IN)

(21) Appl. No.: 18/322,632

(22) Filed: May 24, 2023

(51) Int. Cl. H04M 1/2746; H04M 1/72454; H04M 1/72472

(52) U.S. Cl. CPC H04M 1/2746; H04M 1/72454; H04M 1/72472

(57) ABSTRACT

According to one embodiment, dynamic priority list generation is provided. The embodiment may include gathering metadata for two or more contacts in a contact list in a communication platform or in a profile associated with a user. The embodiment may also include generating a base priority list comprising the two or more contacts based on the gathered metadata. The embodiment may further include gathering progressive metadata for a contact in the base priority list and the user. The embodiment may also include identifying an activity of the user based on the progressive metadata for the user. The embodiment may further include generating a modified priority list based on the base priority list, the activity, and the progressive metadata for the contact. The embodiment may also include generating a graphical user interface, on a user device display screen, displaying the modified priority list.

### BACKGROUND

The present invention relates generally to the field of computing, and more particularly to communication platform user interfaces.

A communication platform relates to any software-based system that enables a user to communicate or correspond with other individuals regardless of the distance between the physical locations of those individuals. Although some communication platforms allow for a single form of communication, such as typed text, audio, or video communication, other communication platforms may allow multiple forms of communication; sometimes concurrently. In order to allow a user to interact with the communication platform, graphical user interfaces are specifically designed to allow user identification and selection of specific contacts with whom users wish to communicate at any specific moment. Typically, such contact lists are ordered alphabetically by contact last name, contact first name, or organization name. Some communication platforms may allow users to select favorite contacts to be included in a separate list for quick location and selection by a user when the user communicates with that contact more frequently than other contacts.

### SUMMARY

According to one embodiment, a method, computer system, and computer program product for dynamic priority list generation is provided. The embodiment may include gathering metadata for two or more contacts in a contact list in a communication platform or in a profile associated with a user. The embodiment may also include generating a base priority list comprising the two or more contacts based on the gathered metadata. The embodiment may further include gathering progressive metadata for at least one contact in the base priority list and the user. The embodiment may also include identifying an activity of the user based on the progressive metadata for the user. The embodiment may further include generating a modified priority list based on the base priority list, the activity, and the progressive metadata for the at least one contact. The embodiment may also include generating a graphical user interface, on a user device display screen, displaying the modified priority list.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a dynamic priority list generation process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to communication platform user interfaces. The following described exemplary embodiments provide a system, method, and program product to, among other things, dynamically modify a contact list presented by a communication platform based on a current user intention. Therefore, the present embodiment has the capacity to improve the technical field communication platform user interfaces by improving usability and accessibility of communication platforms through dynamic customization of the graphical user interface.

As previously described, a communication platform relates to any software-based system that enables a user to communicate or correspond with other individuals regardless of the distance between the physical locations of those individuals. Although some communication platforms allow for a single form of communication, such as typed text, audio, or video communication, other communication platforms may allow multiple forms of communication; sometimes concurrently. In order to allow a user to interact with the communication platform, graphical user interfaces are specifically designed to allow user identification and selection of specific contacts with whom users wish to communicate at any specific moment. Typically, such contact lists are ordered alphabetically by contact last name, contact first name, or organization name. Some communication platforms may allow users to select favorite contacts to be included in a separate list for quick location and selection by a user when the user communicates with that contact more frequently than other contacts.

Many current end user devices capable of connecting to a network, such as, but not limited to, smartphones, personal computers, wearables, and tablets, have a communication platform to allow a user to communicate with other individuals. Typically, such communication platforms enable a user to save contacts. Contacts are a term referring to individuals or organizational entities that a user saves a record of for future communication attempts. Information stored for each contact may include contact name, address, phone number, and email address. Some communication platforms allow a user to manually include a contact in a specific group, such as a favorite contact group. However, a user may wish to prioritize contacts based on a current, contextual situation rather than certain device presets. As such, it may be advantageous to, among other things, implement data gathering of a contextual situation for which a user may be accessing a contact list and prioritize the contact list based on the identified contextual situation.

According to at least one embodiment, a dynamic priority list generation program may gather relevant metadata for each contact on a communication platform installed on a user device. The dynamic priority list generation program may then gather user contextual information related to a scenario or location in which the user is currently present or may be present at a particular future time and sort the contact list based on the metadata and contextual information thereby generating the priority list. The priority list may, therefore, serve as a predictive list presented to the user as the which contacts the dynamic priority list generation program determines the user is likely to contact given the contextual situation. As the contextual situation is ever evolving, the dynamic priority list generation program may regenerate, or reprioritize, the priority list after a preconfigured time.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

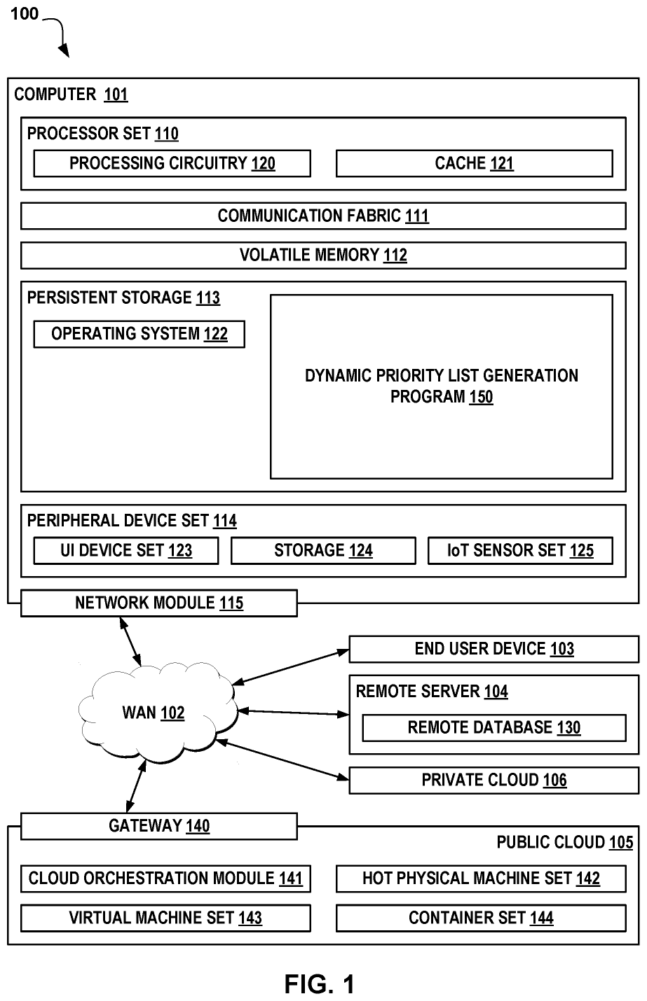

Referring now to FIG. 1, computing environment 100 contains an example of an environment for the execution of at least some of the computer code involved in performing the inventive methods, such as dynamic priority list generation program 150. In addition to dynamic priority list generation program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and dynamic priority list generation program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in dynamic priority list generation program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in dynamic priority list generation program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way. EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to at least one embodiment, the dynamic priority list generation program 150 may be capable of gathering metadata related to each contact stored in a communication platform by the user. In order to gather the metadata, the dynamic priority list generation program 150 may access one or more repositories such as storage 124 and remote database 130. The dynamic priority list generation program 150 may also gather contextual information related to current user access to the priority list. The contextual information may be gathered from the one or more repositories as well as one or more device sensors or data gathered from one or more other programs sharing information with the dynamic priority list generation program 150 either installed on the user device or streamed through a network (e.g., WAN 102) and hosted on a server (e.g., remote server 104). From the contextual information, the dynamic priority list generation program 150 may generate a prediction as to the current contextual scenario in which the user is accessing their contact list. The dynamic priority list generation program 150 may then generate and display a priority list of contacts in the communication platform for the user based on the gathered metadata and contextual scenario gleaned from the contextual information.

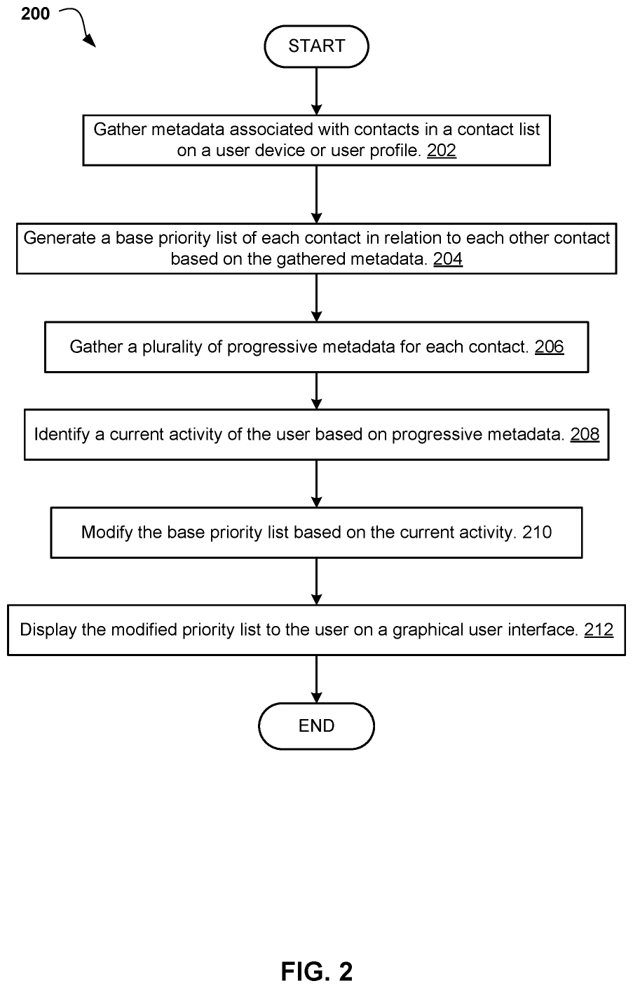

Additionally, prior to initially performing any actions, the dynamic priority list generation program 150 may perform an opt-in procedure. The opt-in procedure may include a notification of the data the dynamic priority list generation program 150 may capture and the purpose for which that data may be utilized by the dynamic priority list generation program 150 during data gathering and operation. Furthermore, notwithstanding depiction in computer 101, the dynamic priority list generation program 150 may be stored in and/or executed by, individually or in any combination, end user device 103, remote server 104, public cloud 105, and private cloud 106. The dynamic priority list generation method is explained in more detail below with respect to FIG. 2.

Referring now to FIG. 2, an operational flowchart illustrating a dynamic priority list generation process 200 is depicted according to at least one embodiment. At 202, the dynamic priority list generation program 150 gathers metadata associated with at least two contacts in a contact list on a user device or user profile. The dynamic priority list generation program 150 may gather various items of metadata pertaining to contacts within the user's contact list for a communication platform in order to provide more information relating to each corresponding contact. The gathered metadata for communications between the contact and the user may include, but is not limited to, date at which the contact was originally saved, communication durations (e.g., number of communications, word length of communications, and time duration of communications), and communication history (e.g., call logs, sent and received emails, and SMS message history).

In one or more embodiments, the dynamic priority list generation program 150 may integrate installations between communication platforms and/or repositories to provide a more robust gathering of contact metadata since users may have different contacts locally stored on different user devices or across different third-party platforms. For example, the dynamic priority list generation program 150 may integrate a contact list on a user smartphone with a contact list in an email service.

Then, at 204, the dynamic priority list generation program 150 generates a base priority list of each contact in relation to each other contact based on the gathered metadata. The dynamic priority list generation program 150 may utilize the various gathered metadata to determine a base priority for the contacts within the contact list. For example, the dynamic priority list generation program 150 may utilize the date at which the contact was originally saved to the user contact list as an indication of when a relationship between the user and the contact began. The dynamic priority list generation program 150 may utilize communication durations as an indication of the strength of the user relationship with the contact since longer communication durations may relate to stronger relationships beyond merely impersonal or business relationships. The dynamic priority list generation program 150 may utilize communication histories to determine a communication frequency and a communication context, when available (e.g., written communications).

The base priority list may organize the contacts for which metadata has been gathered in a preconfigured manner. For example, the dynamic priority list generation program 150 may organize the contacts by communication frequency, communication length, and/or predicted relationship. The preconfigured manner in which the dynamic priority list generation program 150 may generate the base priority list may be determined by a user upon initial installation of the dynamic priority list generation program 150 or through user interactions with a settings menu on a graphical user interface. For example, a user may interact with a settings menu to indicate a preferred base priority to contact with whom the dynamic priority list generation program 150 determines a strong relationship with the user.

In at least one embodiment, the dynamic priority list generation program 150 may predict the relationship or a relationship type or category between the user and a contact based on the metadata gathered for that contact. For example, if a user calls the same number each day on a commute home from work, the dynamic priority list generation program 150 may determine that the user has a strong relationship with the contact, such as a spouse or a parent. Similarly, if the dynamic priority list generation program 150 analyzes SMS messages between a user and a contact that says “Thank you for participating in the meeting today. I took a lot away from our conversation.”, the dynamic priority list generation program 150 may determine a business relationship, such as a coworker or manager, may exist between the user and the contact.

In one or more other embodiments, the dynamic priority list generation program 150 may allow the user to add one or more tags to a contact within the baseline contact list based on any customizable factor. The dynamic priority list generation program 150 may understand the tags as being descriptive of the relationship between the user and the contact or attributes applicable to the contact. The dynamic priority list generation program 150 may utilize natural language processing to understand the meaning of the user-customized tag. For example, the user may add a tag of “emergency” for a specific family member contact. The dynamic priority list generation program 150 may understand this contact is important in emergency situations. In another example, the user may generate a tag of “close friend” for another contact that is indicative of the user and the contact being in a close relationship.

Next, at 206, the dynamic priority list generation program 150 gathers progressive metadata for each contact. Progressive metadata may relate to dynamic metadata that is likely to change over a shorter period of time than contact metadata gathered in step 202. Furthermore, changes in progressive metadata may occur based on the natural progression of the data in the near term whereas updates to contact metadata may only occur when a user updates the contact, such as updating a phone number or address when a contact moves to a new home. Progressive metadata may include, but is not limited to, social media connections, communication content with contacts in the baseline priority list, internet search history, location information, weather information, and audio captured by an audio capture device associated with, or communicatively coupled to, a user device or the dynamic priority list generation program 150. The dynamic priority list generation program 150 may utilize all or a subset of gathered progressive metadata to understand the dynamic changes for the user in real time. For example, the dynamic priority list generation program 150 may utilize progressive metadata to determine that a user is travelling from an origin to a destination and is likely to communicate with a contact upon reaching the destination to let the contact know of the user's arrival. In such a situation, location data may be a helpful item of progressive metadata to determine when the user has arrived at the destination as it indicates a dynamic priority change based on the user's real time actions.

The dynamic priority list generation program 150 may utilize internet search history information to determine current user interests and needs so that appropriate contact priorities may be provided in real time. For example, if a user searches the term “automotive repair near me” through an internet search function, the dynamic priority list generation program 150 may determine the user is in need of automotive repair. Such information may assist the dynamic priority list generation program 150 in generating a priority contact list to present to a user.

The dynamic priority list generation program 150 may utilize weather information to assist in identifying current weather situations the user may experience. Used in conjunction with location information within the progressive metadata, the dynamic priority list generation program 150 may predict whether the user may or is likely to experience an emergency situation. For example, the dynamic priority list generation program 150 may determine the user is staying at a specific hotel based on user location data. The dynamic priority list generation program 150 may then determine that severe weather conditions are about to affect the hotel at which the user is currently residing based on weather information in the progressive metadata.

In one or more embodiments, the dynamic priority list generation program 150 may update contact metadata gathered in step 202 based on varies elements of progressive metadata. The dynamic priority list generation program 150 may determine characteristics of various contacts based on a SMS messaging history between the user and a contact or the user posts to a social media platform. For example, in an SMS conversation with a sibling, the user may indicate they were stung by a bee that day and needed to use their last epinephrine injector so they will need to borrow the one their mother keeps in her purse until the user can purchase another epinephrine injector. In such a scenario, the dynamic priority list generation program 150 may store medically related information to the contact metadata for the user's mother related to the possession of the epinephrine injector.

Then, at 208, the dynamic priority list generation program 150 identifies a current situation of the user based on the progressive metadata. The current situation may include a user status in relation to the environment around the user or an activity in which the user may be currently engaging. Using the progressive metadata and, in one or more embodiments, contact metadata, the dynamic priority list generation program 150 may identify a current user situation through various data items analyzed within the progressive metadata using an artificial intelligence engine. For example, the dynamic priority list generation program 150 may gather progressive metadata from a user social media account that the user plans to go to the beach with a contact on the upcoming Saturday at 11:00 A.M. if the weather is sunny and over 75 degrees fahrenheit. If the dynamic priority list generation program 150 determines the weather information predicts the weather will be 77 degrees fahrenheit on the Saturday planned for the user beach trip, then the dynamic priority list generation program 150 may identify the current situation of the user at 11:00 A.M. is a trip to the beach. The dynamic priority list generation program 150 may further confirm this situation through location information within the priority metadata, if available to the dynamic priority list generation program 150.

As another example, the dynamic priority list generation program 150 may utilize an internet search for car repair from a user in a specific location to determine the user needs automotive assistance at their current location. Therefore, the dynamic priority list generation program 150 may subsequently identify contacts both in the baseline contact list and not on the baseline contact list but nearby the user location that can provide assistance to the user.

In one or more embodiments, the dynamic priority list generation program 150 may continually observe or predict a change to the current user situation, based on the progressive metadata, that requires a modification of the baseline priority list. For example, the dynamic priority list generation program 150 may capture, through a user device microphone, that a medical emergency is happening. Similarly, the dynamic priority list generation program 150 may determine that weather conditions are about to deteriorate, and emergency services may be needed.

Next, at 210, the dynamic priority list generation program 150 modifies the base priority list based on the current situation. The dynamic priority list generation program 150 may modify the baseline priority list based on the contact metadata gathered in step 202 and any applicable progressive metadata gathered in step 206. For example, if the user states “Ouch! I think I was just stung by a bee. Oh no! I don't have my epinephrine injector!”, the dynamic priority list generation program 150 may modify the baseline priority list to prioritize emergency medical services and/or immediate family members that might be able to provide the user with their needed medical assistance.

In one or more embodiments, the dynamic priority list generation program 150 may utilize the progressive metadata and the contact metadata when determining the modified priority of each contact. The dynamic priority list generation program 150 may utilize the progressive metadata to establish the conditions of the current scenario and the contact metadata to determine which contact in the baseline priority list may be most appropriate for the current scenario as established in the progressive metadata. For example, in the previous scenario, the dynamic priority list generation program 150 may determine that the user's mother always carries a spare epinephrine injector as a precaution, but the user's sibling does not. Therefore, the dynamic priority list generation program 150 may prioritize the user's mother high on the modified priority list.

In one or more other embodiments, the dynamic priority list generation program 150 may modify the baseline priority list using contacts within the baseline priority list as well as contacts not within the baseline priority list. For example, in the previous scenario, if the baseline priority list does not contain a contact number for emergency services that may be able to assist the user, the dynamic priority list generation program 150 may identify contact information for one or more emergency services nearest to the user to include in the modified priority list based on information in a third party repository (e.g., remote database 130) to identify the emergency services contact and location tracking information from a user device and the emergency services information.

Then, at 212, the dynamic priority list generation program 150 displays the modified priority list to the user on a graphical user interface. Once the modified priority list is generated, the dynamic priority list generation program 150 may generate a graphical user interface that displays the modified priority list to the user on a graphical user interface of a user device. For example, again continuing the previous scenario, the dynamic priority list generation program 150 may display the modified priority list that prioritizes emergency services contacts and the user's mother in possession of an epinephrine injector to the user when the user unlocks their smartphone and opens a communication platform. By displaying the modified priority list, the dynamic priority list generation program 150 generates an efficient contact mechanism for the user to quickly locate contacts that are likely able to satisfy the current user need.

It may be appreciated that FIG. 2 provides only an illustration of one implementation and does not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
gathering metadata for two or more contacts in a contact list in a communication platform or in a profile associated with a user;
generating a base priority list comprising the two or more contacts based on the gathered metadata;
gathering progressive metadata for at least one contact in the base priority list and the user;
identifying an activity of the user based on the progressive metadata for the user;
generating a modified priority list based on the base priority list, the activity, and the progressive metadata for the at least one contact; and
generating a graphical user interface, on a user device display screen, displaying the modified priority list.

2. The method of claim 1, wherein the progressive metadata comprises dynamic metadata that changes over a period of time due to a natural progression.

3. The method of claim 2, wherein the progressive metadata is selected from a group consisting of social media connections, content of communications between the user and one or more contacts in the base priority list, an internet search history, location information, weather information, and audio captured by an audio capture device.

4. The method of claim 1, wherein the activity is currently engaged in or predicted to be engaged in by the user, and wherein the activity includes a user status in relation to an environment around the user.

5. The method of claim 1, wherein generating the base priority list is further based on a communication frequency, a communication length, and a predicted relationship between the user and each respective contact in the two or more contacts.

6. The method of claim 1, wherein the metadata for the two or more contacts in the contact list is selected from a group consisting of a date at which a contact was added to the contact list, communication time durations between the contact and the user, number of communications between the contact and the user, and a word length of a conversation between the contact and the user.

7. The method of claim 1, wherein gathering the metadata further comprises integrating installations across two or more communication platforms and/or repositories.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
gathering metadata for two or more contacts in a contact list in a communication platform or in a profile associated with a user;
generating a base priority list comprising the two or more contacts based on the gathered metadata;
gathering progressive metadata for at least one contact in the base priority list and the user;
identifying an activity of the user based on the progressive metadata for the user;
generating a modified priority list based on the base priority list, the activity, and the progressive metadata for the at least one contact; and
generating a graphical user interface, on a user device display screen, displaying the modified priority list.

9. The computer system of claim 8, wherein the progressive metadata comprises dynamic metadata that changes over a period of time due to a natural progression.

10. The computer system of claim 9, wherein the progressive metadata is selected from a group consisting of social media connections, content of communications between the user and one or more contacts in the base priority list, an internet search history, location information, weather information, and audio captured by an audio capture device.

11. The computer system of claim 8, wherein the activity is currently engaged in or predicted to be engaged in by the user, and wherein the activity includes a user status in relation to an environment around the user.

12. The computer system of claim 8, wherein generating the base priority list is further based on a communication frequency, a communication length, and a predicted relationship between the user and each respective contact in the two or more contacts.

13. The computer system of claim 8, wherein the metadata for the two or more contacts in the contact list is selected from a group consisting of a date at which a contact was added to the contact list, communication time durations between the contact and the user, number of communications between the contact and the user, and a word length of a conversation between the contact and the user.

14. The computer system of claim 8, wherein gathering the metadata further comprises integrating installations across two or more communication platforms and/or repositories.

15. A computer program product, the computer program product comprising:
one or more computer-readable tangible storage medium and program instructions stored on at least one of the one or more tangible storage medium, the program instructions executable by a processor capable of performing a method, the method comprising:
gathering metadata for two or more contacts in a contact list in a communication platform or in a profile associated with a user;
generating a base priority list comprising the two or more contacts based on the gathered metadata;
gathering progressive metadata for at least one contact in the base priority list and the user;
identifying an activity of the user based on the progressive metadata for the user;
generating a modified priority list based on the base priority list, the activity, and the progressive metadata for the at least one contact; and
generating a graphical user interface, on a user device display screen, displaying the modified priority list.

16. The computer program product of claim 15, wherein the progressive metadata comprises dynamic metadata that changes over a period of time due to a natural progression.

17. The computer program product of claim 16, wherein the progressive metadata is selected from a group consisting of social media connections, content of communications between the user and one or more contacts in the base priority list, an internet search history, location information, weather information, and audio captured by an audio capture device.

18. The computer program product of claim 15, wherein the activity is currently engaged in or predicted to be engaged in by the user, and wherein the activity includes a user status in relation to an environment around the user.

19. The computer program product of claim 15, wherein generating the base priority list is further based on a communication frequency, a communication length, and a predicted relationship between the user and each respective contact in the two or more contacts.

20. The computer program product of claim 15, wherein the metadata for the two or more contacts in the contact list is selected from a group consisting of a date at which a contact was added to the contact list, communication time durations between the contact and the user, number of communications between the contact and the user, and a word length of a conversation between the contact and the user.
